(19) United States
(12) Patent Application Publication
(10) Pub. No.: US 2004/0145142 A1
(43) Pub. Date: Jul. 29, 2004

(54) Structure of skateboard base

(76) Inventor: Sheng-Peng Wang, Taichung (TW)

Correspondence Address: BIRCH STEWART KOLASCH & BIRCH, PO BOX 747, FALLS CHURCH, VA, 22040-0747, US

(21) Appl. No.: 10/352,226

(22) Filed: Jan. 28, 2003

(51) Int. Cl. B62M 1/00

(52) U.S. Cl. 280/87.042

(57) ABSTRACT

The invention provides a structure of skateboard base, which includes a base connected to the underside of the skateboard, a mounting bolt going through the skateboard base longitudinally, and a skateboard support to be connected to the lower part of the skateboard base and to be screwed by the mounting bolt. The left side and the right side of the skateboard support are pivotally connected to a wheel respectively. When a person is making a sliding turn on the skateboard, the turn can be more agilely made by utilizing a moveable component that is matched to the half-ball-shaped concave flange located at the lower part of the skateboard base, or by utilizing a rectangle-shaped axle hole that is located in the middle of the skateboard support to allow the mounting bolt to make a shift inside.

### FIELD OF THE INVENTION

The invention relates to a structure of skateboard base and, more particularly, to an improvement made to the skateboard base underneath the skateboard or an improvement made to the skateboard support that connects two wheels, wherein a mounting bolt enters the skateboard base and the skateboard support to be connected to one another, and the orientation of the mounting bolt can be slightly tilted so that a turning angle can be more agilely made.

### BACKGROUND OF THE INVENTION

Referring to FIGS. 1A and 1B, the structure of a conventional skateboard base includes a base 1, a mounting bolt 2 going through the base 1, and a skateboard support 3 connecting to the other end of the mounting bolt 2, wherein pluralities of mounting holes 11 are located on the periphery of the base 1, allowing the screws 12 to go through so as to fasten the base 1 to the underside of the skateboard A. The mounting bolt 2 can go through a slot 14 located at the bottom of a concave portion 13 that is located at one side of the base 1 and then be engaged with a washer 4 and a shock-absorbing pad 5 serially. After that, the mounting bolt 2 goes through an axle hole 31 in the middle of the skateboard support 3 to be engaged with another shock-absorbing pad 6 and another washer 7, and finally, to be fastened by a screw nut 8. Thus, the structure of a conventional skateboard base is completed, and it can facilitate sliding forward. However, when a human body is making a sliding turn, the turn can be more easily made if a slightly shifting angle can be allowed between the human body and the skateboard A because the turning is affected by the centrifugal force. But unlike that, the skateboard A for a person to step down is screwed to its underside skateboard support 2 longitudinally by a mounting bolt 2, which also fastens the base 1 to the skateboard support 3. Therefore, when the skateboard A on the skateboard base is about to turn, the person's feet have to step right on the skateboard A, whereas the angle of the skateboard A cannot be adjusted along with the tilted angle made by the turn from the person; in other words, the turn cannot not be agilely made.

### SUMMARY OF THE INVENTION

The object of the invention is to improve the structure of the skateboard base in order to solve the above-mentioned problem. The improved structure allows the skateboard to tilt an angle along with the sliding turn made by a human body so that the turn can be agilely made.

The object and technical contents of the invention will be better understood through the description of the following embodiments with reference to the drawings.

### BRIEF DESCRIPTION OF THE DRAWINGS

FIG. 1A is a three-dimensional view of a conventional structure of assembling a skateboard base.

FIG. 1B is a sectional view of 1B to 1B that is shown in FIG. 1A after the skateboard has been assembled.

FIG. 2 is a three-dimensional exploded view of the first embodiment of the invention.

FIG. 3 is a plan sectional view of assembling the first embodiment of the invention.

FIG. 4 is a three-dimensional exploded view of the second embodiment of the invention.

FIG. 5 is a plan sectional view of assembling the second embodiment of the invention.

FIG. 6 is a three-dimensional view of a mounting bolt in another embodiment of the invention.

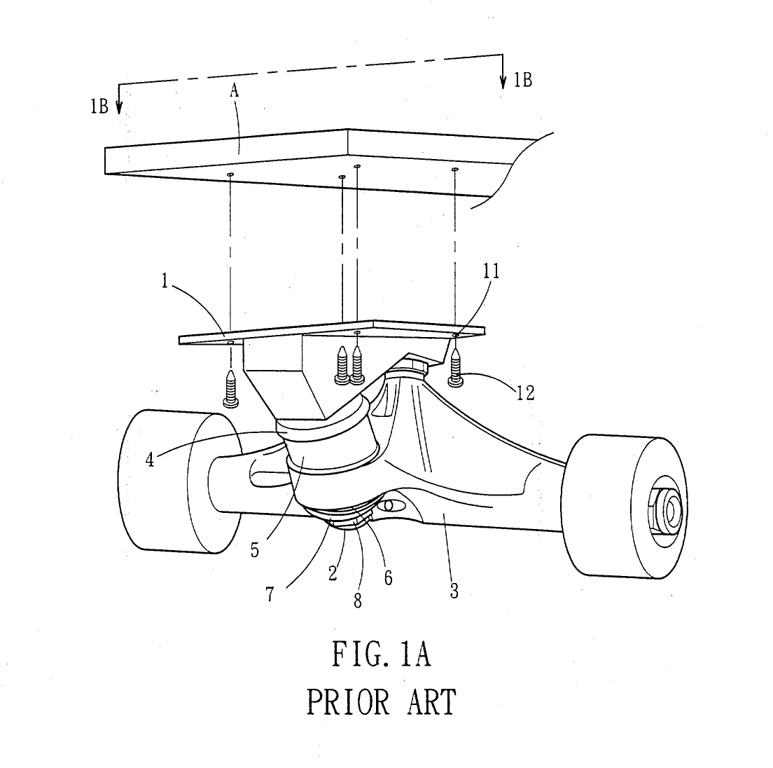

### DESCRIPTION OF THE PREFERRED EMBODIMENT

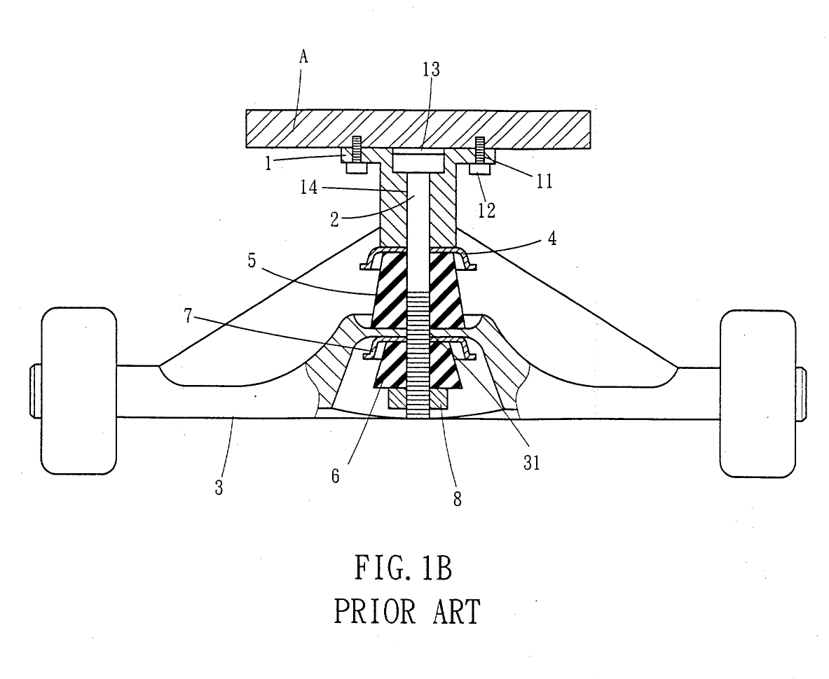

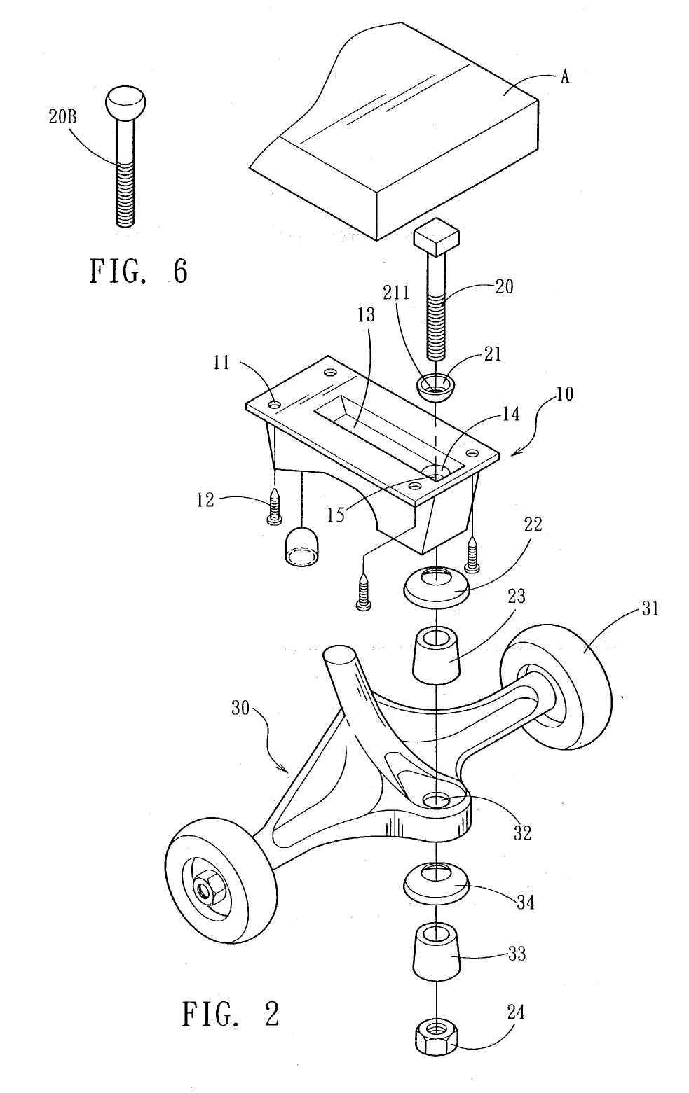

Referring to FIGS. 2 and 3, a structure of skateboard base of the invention includes a base 10 that is connected to the underside of the skateboard A; a mounting bolt 20 going longitudinally through the base 10; and a skateboard support 30 connected to the other end of the mounting bolt 20. The surfaces of the base 10 are rectangle plates, wherein pluralities of mounting holes 11 are located on the periphery of the base 10. Besides, pluralities of screws 12 can fit in each mounting hole 11 to fasten the base 10 to the underside of the skateboard A. Moreover, a rectangle-shaped concave portion 13 is located inside the skateboard base, and a half-ball-shaped concave flange 14 is located at the lower side of the concave portion 13. A moveable component 21 placed on the mounting bolt 20 is to match the concave flange 14. Besides that, a hole 15 is located in the middle of the concave flange 14. Also, the mounting bolt 20 can go through the component hole 211 of the moveable component 21. The left side and the right side of the skateboard support 30 are pivotally connected to a wheel 31 respectively. An axle hole 32 is located longitudinally in the middle of the skateboard support 30, and the diameter of the axle hole is a bit larger than the mounting bolt 20.

When it comes to assembling, first, the mounting bolt 20 is put into the component hole 211 of the moveable component 21, and then the moveable component 21 is engaged with the hole 15 of the concave flange 14 of the skateboard base. The mounting bolt 20 will then serially go through a washer 22 made of metal, a shock-absorbing pad 23 made of rubber, the axle hole 32 of the skateboard support 30, another washer 34 and another shock-absorbing pad 33, and finally to be fastened by a screw nut 23.

When the skateboard A is in use, a person's feet are stepping on the deck of it. The person's body will be tilting to one side when making a turn because his body is affected by the centrifugal force. Despite that the base 10 is fastened underneath the skateboard A, the moveable component 21 of the invention can turn around freely inside the concave flange 14 since it is designed to match the half-ball-shaped concave flange 14 of the base 10. In addition, because the mounting bolt 20 goes through the component hole 211 of the moveable component 21 and because the lower part of the mounting bolt 20 also goes through the axle hole 32 of the skateboard support 30 to be fastened by the screw nut 24, the mounting bolt 20 and the skateboard support 30 can also be slightly slanted when a turn is made. Moreover, because the upper part of the mounting bolt 2 goes through the moveable component 21, the half-ball-shaped moveable component 21 can then turn around slightly inside the concave flange 14 of the base 10, allowing the base 10 to make a slightly tilted angle along with the shift made by the mounting bolt. By applying the tilting effect made by the base 10, the person's feet are capable of controlling the skateboard A as well as making a tilt at turning so that the person can respond agilely to the turning of the wheels 31.

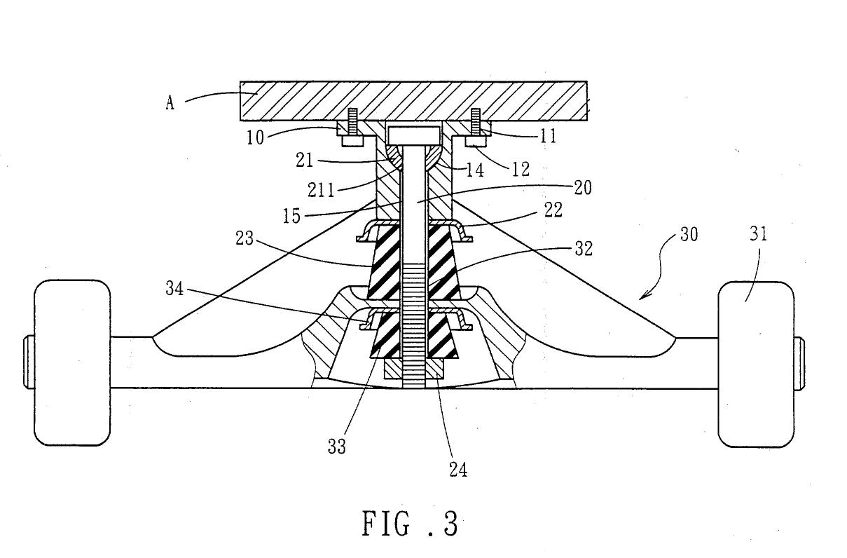

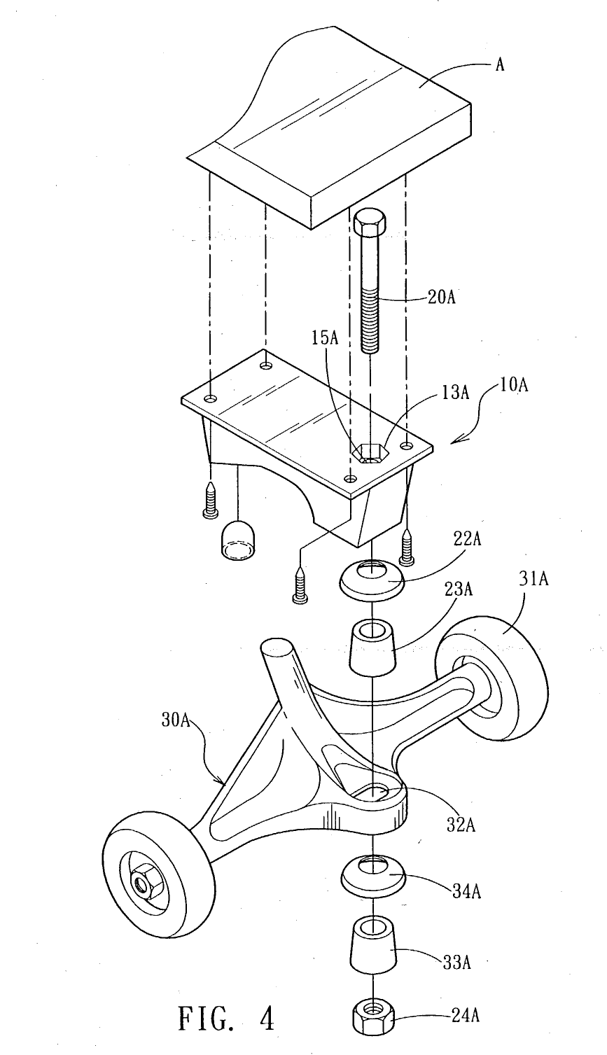

Next, referring to FIGS. 4 and 5, the invention provides another embodiment that is different from the foregoing first embodiment by the variation to be described below. A rectangle-shaped axle hole 32A is provided at the middle of the skateboard support 30A along its orientation. The rectangle-shaped axle hole 32A allows the mounting bolt 20A located inside to make a left-and-right shift angle. Besides, a round-shaped concave portion 13A is provided in the middle of the base 10A. Also, a hole 15A is provided at the bottom of one side of the concave portion 13A to be entered by the mounting bolt 20A. In particular, the concave portion 13A can only exactly accommodate the head of the mounting bolt 20A. During the assembly, the mounting bolt 20A enters the hole 15A of the base 10A and then goes through a washer 22A, a shock-absorbing pad 23A, the rectangle-shaped axle hole 32A of the skateboard support 30A, another washer 34A and another shock-absorbing pad 33A, and finally to be fastened by a screw nut 24A.

Now, when the wheels 31A of the skateboard A are making a turn, the mounting bolt 20A can also make a slight tilt inside the rectangle-shaped axle hole 32A of the skateboard support 30A. Meanwhile, the skateboard 10A that accommodates the upper part of the mounting bolt 20A can also make a tilted angle correspondingly, which in turn allows the skateboard A that is screwed to the skateboard 10 to make a tilted angle simultaneously. Therefore, when a person is making a turn on the skateboard A, the person is capable of making a turn more agile through the tilted angle of the body.

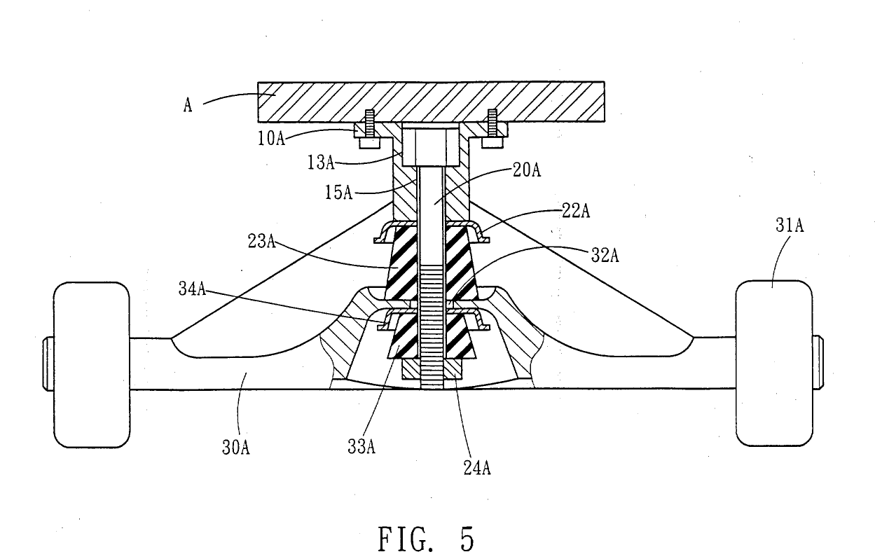

Furthermore, referring to FIG. 6, according to the aspect of another embodiment, the head of the mounting bolt 20B of the invention has a shape of half ball, which can be placed inside the concave flange 14 of the base 10. Likewise, the skateboard A with such structure has the same function as what has been described above with reference to the FIGS. 2 and 3, in which the function is performed by the mounting bolt 20 along with the moveable component 21.

What is claimed is:

1. A structure of skateboard base, wherein the skateboard base is connected to the underside of the skateboard, including:
a base, wherein a hole is provided in the middle of the base;
a skateboard support, wherein an axle hole is provided in the middle of the skateboard support along its orientation, and the diameter of the axle hole is larger than the mounting bolt; besides, the left side and the right side of the skateboard support are pivotally connected to a wheel respectively; and
a mounting bolt, which passes through the hole in the base and the axle hole of the skateboard support to be screwed together with relative components;
wherein a half-ball-shaped concave flange is provided longitudinally in the base, and a movable component is provided on the mounting bolt with a shape that can be matched to the concave flange in the base; through such arrangement, the movable component can turn around inside the concave flange freely.

2. The structure of skateboard base as claimed in claim 1, wherein after the mounting bolt enters the hole of the skateboard base, the mounting bolt will also go through a washer, a shock-absorbing pad, the axle hole of the skateboard support, another shock-absorbing pad and another washer, and finally to be fastened by a screw nut.

3. The structure of skateboard base as claimed in claim 1, wherein the component hole of the moveable component is to be entered by the mounting bolt for exactly accommodating the head of the mounting bolt.

4. A structure of skateboard base, wherein the skateboard base is connected to the underside of the skateboard, including:
a base, wherein a concave portion is located at the base along the orientation of the base, and a hole is located in the middle of the concave portion;
a skateboard support, wherein a rectangle-shaped axle hole is provided in the middle of the skateboard support along its orientation, and the left side and the right side of the skateboard support are pivotally connected to a wheel respectively; and
a mounting bolt, which passes through the hole of the base and the rectangle-shaped axle hole; besides, the rectangle-shaped axle hole can provide a space to accommodate the mounting bolt's moving inside so that the skateboard support is able to make a shift.

5. The structure of skateboard base as claimed in claim 1, wherein after the mounting bolt enters the hole of the base, the mounting bolt will also go through a washer, a shock-absorbing pad, the axle hole of the skateboard support, another shock-absorbing pad and another washer, and finally to be fastened by a screw nut.
